(19) United States
(12) Patent Application Publication
(10) Pub. No.: US 2014/0198385 A1
(43) Pub. Date: Jul. 17, 2014

(54) LarView Technologies Corporation

(71) Applicant: LARVIEW TECHNOLOGIES CORPORATION, Taoyuan County (TW)

(72) Inventor: Yu Te CHOU, New Taipei City (TW)

(73) Assignee: LARVIEW TECHNOLOGIES CORPORATION, Taoyuan County (TW)

(21) Appl. No.: 13/740,206

(22) Filed: Jan. 13, 2013

(51) Int. Cl. G02B 27/00

(52) U.S. Cl. CPC G02B 27/0006
USPC 359/507

(57) ABSTRACT

The present invention provides an auto focus camera module structure for particles protection. The structure comprises a lens. An actuator is used to support the lens. A coil is configured on the actuator. A magnet material is disposed adjacent to the coil. A holder is used to support the actuator. A transparent material is disposed under the holder. A flexible material or compressible material is disposed between the actuator and the holder for blocking particles entering into the module structure.

### TECHNICAL FIELD

The present invention generally relates to a semiconductor device module structure, more particularly, to an auto focus camera module structure for particles protection by utilizing a specified design of a flexible material or a compressible material in the actuator assembly for blocking particles entering inside the surface of a transparent plate to reduce the percentage for particles.

### BACKGROUND

A traditional camera module includes an image sensor and one or more lens set. The lens set is disposed above the image sensor for the incident ray image mapping to the image sensor. Camera module with the image sensor has many relevant applications including digital cameras, digital video recorders, mobile phones, smart phones, monitors and others electronic products with camera function.

For the camera module, which pixel size of the image sensor is smaller and smaller, dust to the impact of imaging quality is increasing significantly. In the current scheme of the camera module, there is no special design between the lens and the lens holder. Therefore, both the dust from outside and particles generated from the lens assembling with the lens holder will enter inside of the camera module through the gap between the lens and the lens holder. The resulting imaging quality of the camera module is thus affected.

To address the shortcomings of prior arts, a newly chip module structure is proposed for particles protection for enhancing imaging quality of the camera module.

### SUMMARY OF THE INVENTION

To address the above shortcomings, an auto focus camera module structure for particles protection is proposed to reduce the percentage of particles entering into a transparent plate.

Another objective of the present invention is to provide an auto focus camera module structure by integrating a flexible material in assembling actuator for particles protection to block particles entering into the module structure.

According to an aspect of the present invention, the present invention provides an auto focus camera module structure for particles protection. The structure comprises a lens. A driving mechanism is used to support the lens. A coil is configured on the driving mechanism. A magnet material is disposed adjacent to the coil. A holder is used to support the driving mechanism. A transparent material is disposed under the holder. A flexible material or compressible material is disposed between the driving mechanism and the holder for blocking particles entering into the module structure.

The auto focus camera module structure further comprises a housing to cover the camera module structure. The magnet is disposed on the holder. The coils are disposed between the magnet and the driving mechanism. The flexible material comprises rubber, natural rubber, synthetic rubber, or nano elastomer composite, and the compressible material comprises foam, fiber, natural rubber, or synthetic rubber. The driving mechanism includes a voice coil motor or a micro electro mechanical system.

### BRIEF DESCRIPTION OF THE DRAWINGS

The components, characteristics and advantages of the present invention may be understood by the detailed descriptions of the preferred embodiments outlined in the specification and the drawings attached:

FIG. 1A illustrates a sectional view of an auto focus camera module structure;

FIG. 1B illustrates a sectional view of an auto focus camera module structure, wherein the driving mechanism moving upward;

FIG. 2A illustrates a sectional view of an auto focus camera module structure for particles protection according to one embodiment of the invention;

FIG. 2B illustrates a sectional view of an auto focus camera module structure for particles protection according to one embodiment of the invention, wherein the driving mechanism moving upward.

### DETAILED DESCRIPTION

Some preferred embodiments of the invention are next described in further detail. Notably, however, the preferred embodiments of the invention are provided for illustration purposes rather than for limiting the use of the invention. The invention is also applicable in many other embodiments besides those explicitly described, and the scope of the present invention is not expressly limited except as specified in the accompanying claims.

An auto focus camera module structure is proposed for particles protection. In the module structure, a flexible material or a compressible material is disposed on the bottom of actuator or carrier thereof which occupies the gap between the carrier and the holder. The particles can not escape from the gap to reduce or prevent some particles from entering inside of a transparent plate along the sidewall of the gap, without affecting the imaging quality of the camera module. In other words, the module structure of the present invention utilizes a specified design for the flexible material or the compressible material disposed between the actuator and holder to effectively reduce or prevent micro particles from entering inside of the transparent plate along the gap between the actuator and holder (housing), and thereby effectively enhancing the imaging quality of the image sensor and yield of the camera module structure.

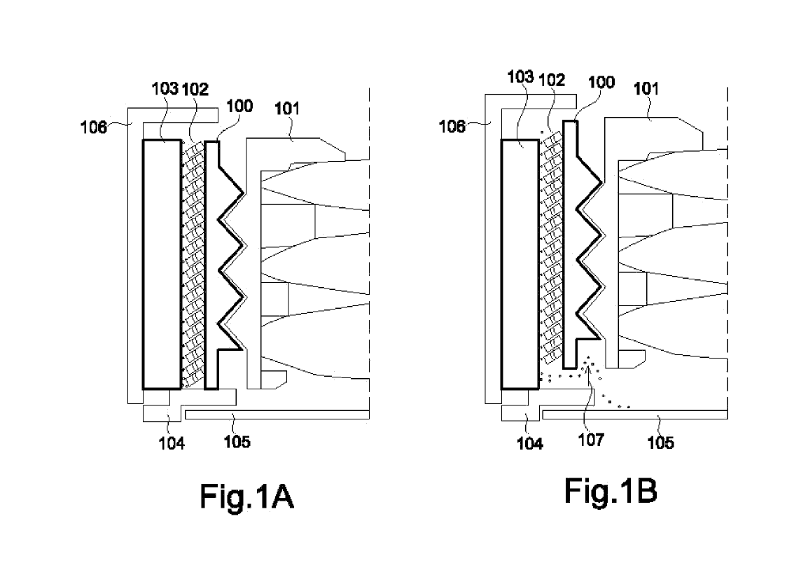

FIG. 1A shows a sectional view of an auto focus camera module structure. The auto focus camera module structure may be applied as camera module of mobile phone. As shown in FIG. 1A, the auto focus camera module structure comprises a driving mechanism 100, a lens 101, coils 102, a magnet (magnetic structure) 103, a holder 104, a transparent material (plate) 105 and housing 106. The auto focus camera module structure further comprises printed circuit board or flexible printed circuit board and image sensor chip (not shown), wherein the image sensor chip is disposed under the transparent plate 105. The image sensor chip has a sensing area and contact pads formed thereon. The housing 106 covers the whole module structure.

The driving mechanism 100 may be an actuator disposed on the holder 104. For example, the actuator includes voice coil motor (VCM) or micro electro mechanical system (MEMS) structure. Currently, in the imaging apparatus, the voice coil motor is generally applied to drive lens of the camera module for focusing. Moreover, the magnet 103 is disposed on the holder 104. The coils 102 is disposed between the magnet 103 and the driving mechanism 100. The coils 102 is adhered on the driving mechanism 100. In one embodiment, the coils 102 is embedded into the driving mechanism 100. The driving mechanism 100 integrates with the lens 100 for driving the lens 101.

The holder 104 can support the magnet 103 and the driving mechanism 100. The transparent plate 105 is disposed under the holder 104. The transparent plate 105 is for example a glass substrate or the plate made of a transparent material. The transparent plate 105 is located above substrate for covering the sensing area of the image sensor chip. The transparent plate 105 covers the sensing area of the image sensor chip to reduce particles contamination for enhancing yield of the module structure. Size of the transparent plate 105 may be the same or larger than area of the sensing area.

The transparent plate (optical filter) 105 may be round or square type. The transparent plate 105 may be optionally coated with infrared coating layer for filtering, such as infrared filter for filtering to a certain band of frequency by passing through the lens 101.

The lens 101 is fixed to the driving mechanism 100 for supporting the lens 101. In the module structure of this embodiment, the transparent plate 105 may be optionally disposed under the lens 101. In other words, the lens 101 is substantially aligning to the transparent plate 105 and the image sensor chip.

As the module structure is assembled, between the magnet 103 and the driving mechanism 100 (or coils 102) may not be able to completely seal together, causing a slight gap (slit) at the seam there-between. Therefore, a part of fine (micro) particles may move down along the gap/slit (sidewall) between the magnet 103 and the driving mechanism 100 (or coils 102) and stay there-between, shown in FIG. 1A.

When electric current is applied on the coils 102, based on the interaction between the magnet 103 and the coils 102, the drive mechanism 100 can be driven to move upward a distance 107, shown in FIG. 1B. For example, when shooting long-shot at afocal end (infinite side) by the auto-focus camera module, the lens needs to be close to the holder 104 for focusing; when shooting close-range at macro side by the auto-focus camera module, the lens needs away from the holder 104 for focusing. Accordingly, in order to focus, the driving mechanism 100 needs moving back and forth in the vertical direction of the holder 104. The driving mechanism 100 can drive the lens 101 to move so that the lens 101 is close to or away from the holder 104 to facilitate focusing. When the driving mechanism 100 moves upward a distance 107, there will be a gap between the driving mechanism 100 and the holder 104. Fine particles stayed on the holder 104 and between the magnet 103 and the driving mechanism 100 or the coils 102 can further move into the transparent plate 105 in the above gap, which may contaminate the surface of the transparent plate 105, shown in FIG. 1B. Fine particles stayed on the holder 104 will affect the imaging quality of the image sensor chip. In other words, in the module structure of the FIG. 1B, a part of fine particles may move along the slits (sidewall) between the magnet 103 and the driving mechanism 100 or the coils 102 into the transparent plate 105, and the fine particles will stay on the upper surface of the transparent plate 105, and thereby affecting the imaging quality of the image sensor chip after light passing through the transparent plate 105.

As described above, when shooting by the auto-focus camera module, the gap will be created between the driving mechanism 100 (or carrier thereof) and the holder 104 as the driving mechanism moves from the afocal end (infinite side) to the macro side, and thereby affecting the imaging quality of the image sensor chip because the fine particles or dusts enter into the camera module structure.

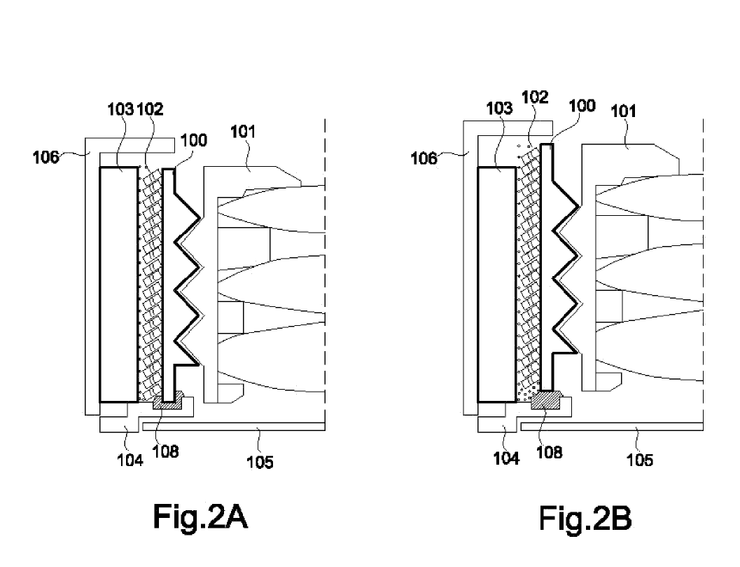

As shown in FIG. 2A, it shows a sectional view of an auto focus camera module structure for particles protection according to an embodiment of the present invention. In this embodiment, the auto focus camera module structure further includes the flexible material or compressible material 108 disposed on the bottom of the driving mechanism 100 or carrier thereof, or between the driving mechanism 100 and the holder 104. Others configuration of the module structure may be referred to the FIG. 1A. The flexible material or compressible material 108 is disposed between the bottom of the driving mechanism 100 and the top surface of the holder 104. The flexible material or compressible material 108 is disposed for the gap between the bottom of the driving mechanism 100 and the top surface of the holder 104 to be enclosed. The particles can not escape from the gap to reduce or prevent some particles from entering inside of the transparent plate 105 along the sidewall of the gap. In other words, the module structure of the present invention utilizes a specified design for the flexible material or the compressible material 108 disposed between the driving mechanism 100 and the holder 104 to effectively reduce or prevent micro particles from entering inside of the transparent plate 105 along the gap between the driving mechanism 100 and the housing 106 (or magnet 103), and thereby effectively enhancing the imaging quality of the image sensor.

The flexible material or compressible material 108 does not contact with the lens 101 or the magnet 103. In one embodiment, flexible material 108 comprises rubber, natural rubber, synthetic rubber, or nano elastomer composite. The compressible material 108 comprises foam, fiber, natural rubber, or synthetic rubber.

When the driving mechanism 100 moves upward a distance, the flexible material or compressible material 108 is then extending upwardly. Because of the flexible characteristic of the flexible material 108 (or compressible characteristic of the compressible material), the flexible material or compressible material 108 occupies the space between the driving mechanism 100 and the holder 104 without creating a gap, shown in FIG. 2B. Therefore, fine particles still remain on the top surface of the holder 104 and between the magnet 103 and the driving mechanism 100 or the coils 102, without passing over the upper surface of the transparent plate 105.

As above-mentioned, the flexible characteristic of the flexible material is disposed on the holder 104 of the auto focus camera module structure. Utilizing the characteristic of the flexible material connected between the holder 104 and the driving mechanism 100 or carrier thereof, when shooting from afocal end (infinite side) to macro side by the auto-focus camera module, there is no gap between the driving mechanism 100 and the holder 104. Therefore, particles are not entering into the camera module structure, and thereby enhancing the imaging quality of the camera module structure.

In the camera module structure of the present invention, fine particles will not stay on the transparent plate 105, ruling out the possibility of particles affecting the image sensor chip. The fine particles described above, for example, are dusts coming from outside or dusts generated as the lens and the driving mechanism assembling.

The foregoing descriptions are preferred embodiments of the present invention. As is understood by a person skilled in the art, the aforementioned preferred embodiments of the present invention are illustrative of the present invention rather than limiting the present invention. The present invention is intended to cover various modifications and similar arrangements included within the spirit and scope of the appended claims, the scope of which should be accorded the broadest interpretation so as to encompass all such modifications and similar structures.

What is claimed is:

1. An auto focus camera module structure for particles protection, comprising:
a lens;
a driving mechanism for supporting said lens;
a coils disposed on said driving mechanism;
a magnet disposed adjacent to said coils;
a holder for supporting said driving mechanism; and
a flexible material disposed between said driving mechanism and said holder for blocking particles entering into said camera module structure.

2. The module structure of claim 1, wherein said magnet is disposed on said holder.

3. The module structure of claim 1, wherein said coils is disposed between said magnet and said driving mechanism.

4. The module structure of claim 1, wherein said flexible material comprises rubber, natural rubber, synthetic rubber, or nano elastomer composite.

5. The module structure of claim 1, wherein said driving mechanism includes a voice coil motor or a micro electro mechanical system.

6. The module structure of claim 1, further comprising a transparent material disposed under said holder.

7. The module structure of claim 6, wherein said magnet is disposed on said holder.

8. The module structure of claim 6, wherein said coils is disposed between said magnet and said driving mechanism.

9. The module structure of claim 6, wherein said flexible material comprises rubber, natural rubber, synthetic rubber, or nano elastomer composite.

10. The module structure of claim 6, wherein said driving mechanism includes a voice coil motor or a micro electro mechanical system.

11. An auto focus camera module structure for particles protection, comprising:
a lens;
a driving mechanism for supporting said lens;
a coils disposed on said driving mechanism;
a magnet disposed adjacent to said coils;
a holder for supporting said driving mechanism; and
a compressible material disposed between said driving mechanism and said holder for blocking particles entering into said camera module structure.

12. The module structure of claim 11, wherein said magnet is disposed on said holder.

13. The module structure of claim 11, wherein said coils is disposed between said magnet and said driving mechanism.

14. The module structure of claim 11, wherein said compressible material comprises foam, fiber, natural rubber, or synthetic rubber.

15. The module structure of claim 11, wherein said driving mechanism includes a voice coil motor or a micro electro mechanical system.

16. The module structure of claim 11, further comprising a transparent material disposed under said holder.

17. The module structure of claim 16, wherein said magnet is disposed on said holder.

18. The module structure of claim 16, wherein said coils is disposed between said magnet and said driving mechanism.

19. The module structure of claim 16, wherein said compressible material comprises foam, fiber, natural rubber, or synthetic rubber.

20. The module structure of claim 16, wherein said driving mechanism includes a voice coil motor or a micro electro mechanical system.
